(19) United States
(12) Patent Application Publication
(10) Pub. No.: US 2004/0047306 A1
(43) Pub. Date: Mar. 11, 2004

(54) Communication terminal adaptable for different communication methods, and antenna duplexer and power amplifier usable in the communication terminal

(75) Inventors: Makoto Katagishi, Chigasaki (JP); Yoshikazu Sugiyama, Ebina (JP); Taku Takaki, Fujisawa (JP); Osamu Hasegawa, Mito (JP)

Correspondence Address: McDermott, Will & Emery, 600, 13th Street, N.W., Washington, DC, 20005-3096, US

(73) Assignee: Hitachi, Ltd.

(21) Appl. No.: 10/234,153

(22) Filed: Sep. 5, 2002

(51) Int. Cl. H04B 7/204; H04B 7/216

(52) U.S. Cl. 370/320; 370/321

(57) ABSTRACT

A communication terminal having: an antenna duplexer in which a low-pass filter using a first frequency band as a pass band and a high-pass filter using a second frequency band as a pass band are connected to an antenna, a radio frequency switch for switching a signal of the first frequency band in accordance with transmission and reception timings of the TDMA is provided, and a radio frequency switch for switching a signal of the second frequency band in accordance with the transmission and reception timings of the TDMA and switching a connecting destination to the connection to the duplexer upon CDMA communication is provided; and a controller for controlling the switching operation of the radio frequency switches provided in the antenna duplexer in an interlocking relational manner with the switching of a communication mode of a modulator/demodulator.

### BACKGROUND OF THE INVENTION

The invention relates to a communication terminal which is adaptable to at least one communication method in a frequency band of 1 GHz or lower and is adaptable to at least two communication methods in a frequency band over 1 GHz.

The invention further relates to a communication terminal which can perform a handover (communication methods are switched without interruption) between a frequency band of 1 GHz or lower and a frequency band over 1 GHz.

There is a TDMA (Time-Division Multiple Access) as one of accessing methods of cellular phones which are the mainstream at present. The PDC standard (RCRSTD-27 specified by Association of Radio Industries and Businesses (ARIB)) of Japan and the GSM standard (TS100-910 specified by the ETSI, or the like) of various foreign countries such as European countries in the main use the TDMA as an accessing method. In those standards, transmission and reception are time-divisionally executed and the transmission and the reception are executed at different time.

There is a CDMA (Code-Division Multiple Access) as an accessing method which has been spread in U.S.A., Korea, and Japan in recent years. As typical standards, there are TIA IS-95 of U.S.A. and ARIB STDT-53 of Japan and, according to those standards, the transmission and the reception are simultaneously executed.

As literatures showing constructional examples of the foregoing communication terminal which uses both of the TDMA in which transmission timing and reception timing are different and the CDMA in which the transmission and the reception are simultaneously executed, JP-A-2000-156651, JP-A-10-107678, and JP-A10-84299 can be mentioned. According to them, since different communication methods are switched by using a radio frequency switch, interruption of communication occurs when the communication methods are switched.

Services of cellular phones in a frequency range from a 800 MHz band to a 900 MHz band and cellular phones (PHS in Japan) of a 1.8 GHz band or a 1.9 GHz band are provided in respective countries. The expression 800 MHz band, 900 MHz band, 1.8 GHz band, or 1.9 GHz band is used in order to easily express a band including a certain frequency by representing it by the frequency included in such a band or a just frequency near such a band. Usually, such a band lies within a range of ±10% of the representative frequency. For example, the 900 MHz band generally denotes a frequency range of 810 MHz to 990 MHz. In Europe and the like, a dual band terminal which can be connected to the communication services of two of the foregoing different frequency bands, for example, a terminal which is adaptable to the 900 MHz band and the 1.8 GHz band in the GSM is the mainstream.

According to the conventional techniques, a technique for realizing the handover between the TDMA dual band terminal and the CDMA which is used in a communication method of cellular phones of the third generation is not disclosed.

### SUMMARY OF THE INVENTION

It is an object of the invention to provide a communication terminal which is adaptable to at least one communication method in a frequency band of 1 GHz or lower and is adaptable to at least two communication methods in a frequency band over 1 GHz.

Another object of the invention is provide a construction which can realize a communication terminal which is adaptable to a communication method like a CDMA in which the transmission and the reception are simultaneously executed and a communication method like a TDMA in which the transmission and the reception are executed at different time, thereby enabling a handover between both of those methods. In the invention, in the case where the communication method differs depending on an area, a function for switching the communication methods without interrupting the communication when the user is moved to the area of the different method is defined as “handover” between both methods.

To accomplish the above objects, according to the invention, there is provided a communication terminal which is adaptable to at least two communication methods, wherein communication by a first method can be made in a first frequency band and communication by a second method or a third method can be selected at a frequency band higher than the first frequency band.

According to the invention, there is provided a communication terminal which is adaptable to at least two communication methods, wherein communication by a first method can be made in a frequency band of 1 GHz or lower and communication by a second method or a third method can be selected at a frequency band over 1 GHz.

According to a preferred embodiment, the second method and the third method are different methods and the first method is the same as either the second method or the third method.

According to another preferred embodiment, the second method and the third method are different methods and the first method is different from both of the second method and the third method.

According to further another preferred embodiment, the second method is the TDMA and the third method is the CDMA.

According to the invention, a communication terminal which is adaptable to three communication methods can be obtained, and a communication terminal in which even if the user is moved to an area where a frequency and a communication method are different, a connecting destination can be switched without interrupting communication, and excellent use convenience is obtained can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a constructional diagram showing the first embodiment of the invention;

FIG. 2 is a constructional diagram showing the second embodiment of the invention;

FIG. 3 is a constructional diagram showing the third embodiment of the invention;

FIG. 4 is a constructional diagram showing the fourth embodiment of the invention;

FIG. 5 is a flowchart showing an example of a setting flow of an antenna duplexer which is executed by a controller in the first embodiment;

FIG. 6 is a flowchart showing an example of a setting flow of a power amplifier which is executed by the controller in the first embodiment;

FIG. 7 is a flowchart showing an example of a setting flow of the antenna duplexer which is executed by the controller in the first embodiment;

FIG. 8 is a flowchart showing an example of a setting flow of an antenna duplexer which is executed by a controller in the second embodiment; and

FIG. 9 is a flowchart showing an example of a setting flow of the antenna duplexer which is executed by the controller in the second embodiment.

### DESCRIPTION OF THE EMBODIMENTS

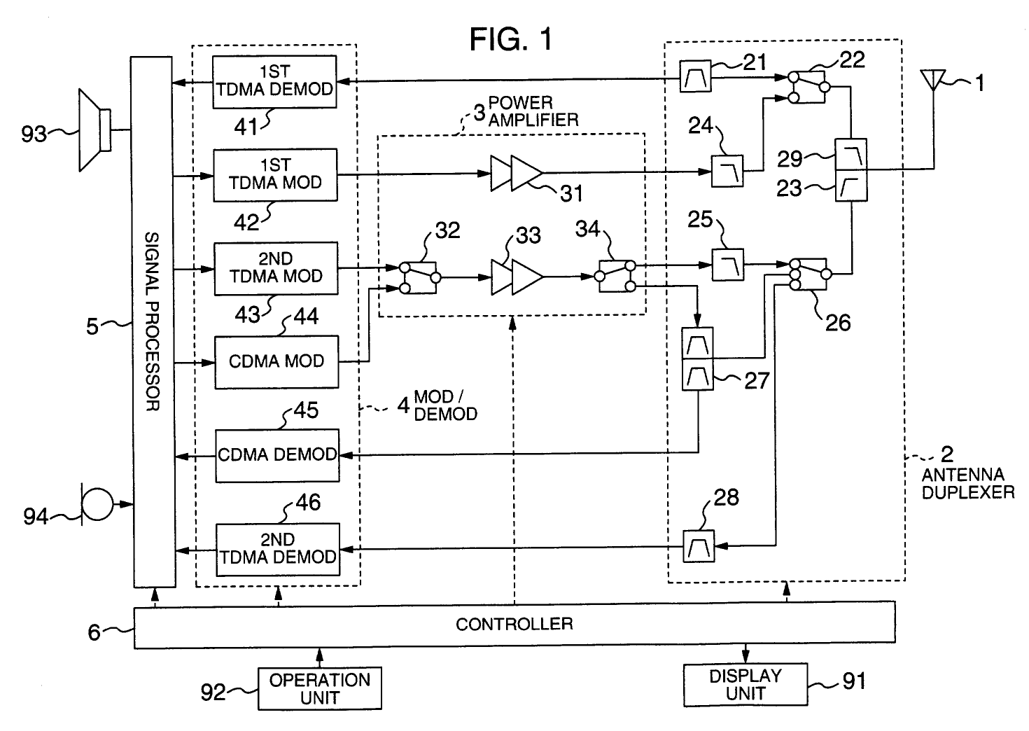

Embodiments of the invention will be described in detail hereinbelow with reference to FIGS. 1 to 9. An explanation will now be made with respect to examples on the assumption that the TDMA method of the 900 MHz band is used as a first communication method, the TDMA method of the 1800 MHz band is used as a second communication method, and the CDMA method of the 2 GHz band is used as a third communication method, respectively.

The first embodiment of the invention will be described with reference to FIGS. 1, 5, 6, and 7.

FIG. 1 is a system constructional diagram of a TDMA/CDMA duplex communication terminal showing the first embodiment of the invention. The terminal is mainly constructed by: an antenna duplexer 2; a modulator/demodulator 4 having a modulator and a demodulator of the TDMA and a modulator and a demodulator of the CDMA; a power amplifier 3 for amplifying an output of the modulator in the modulator/demodulator 4 and supplying it to the antenna duplexer 2; a signal processor 5 connected to the modulator/demodulator 4; and a controller 6 for controlling the antenna duplexer 2, modulator/demodulator 4, power amplifier 3, and signal processor 5. An operation unit 92 for executing various inputting operations and a display unit 91 for displaying information inputted from the operation unit, received information, information necessary for the operation, or the like are further connected to the controller 6. A speaker 93 serving as a receiver and a microphone (hereinafter, abbreviated to “mic”) 94 serving as a transmitter are connected to the signal processor 5. A signal received by an antenna 1 is supplied to each of the TDMA demodulator and the CDMA demodulator in the modulator/demodulator 4 via the antenna duplexer 2. Outputs of the TDMA modulator and the CDMA modulator in the modulator/demodulator 4 are supplied to the antenna duplexer 2 via the power amplifier 3, respectively. An internal construction of each unit will be described hereinbelow.

As shown in FIG. 1, the antenna duplexer 2 has a low-pass filter 29 and a high-pass filter 23 which are connected to the antenna 1. The low-pass filter 29 is selectively connected to a band-pass filter 21 and a low-pass filter 24 via a change-over switch 22. The high-pass filter 23 is selectively connected to band-pass filters 27 and 28 and a low-pass filter 25 via a change-over switch 26. The band-pass filter 27 operates as a duplexer for CDMA. The low-pass filter 29 sets a band (900 MHz band) including a first frequency (low frequency) to a pass band. The high-pass filter 23 sets a band (from a 1800 MHz band to a 2 GHz band) including a second frequency (high frequency) to a pass band. One of signal terminals of the low-pass filter 29 and one of signal terminals of the high-pass filter 23 are constructed as a common terminal and connected to the antenna 1. The other signal terminal of the low-pass filter 29 is connected to the first radio frequency switch 22 as a change-over switch. The other signal terminal of the high-pass filter 23 is connected to the second radio frequency switch 26 as a change-over switch. One of switching destinations of the first radio frequency switch 22 is connected to a first TDMA demodulator 41 provided in the modulator/demodulator 4 via the band-pass filter 21, and the other is connected to an output terminal of a first frequency band provided for the power amplifier 3 via the low-pass filter 24. The first radio frequency switch 22 can switch a signal of the first frequency band in accordance with transmission and reception timings of the TDMA. By the above construction, transmission and reception signal paths of the TDMA in the first frequency band can be properly switched and the signal can be transmitted and received to/from the modulator/demodulator 4.

The second radio frequency switch 26 has three switching destinations. The first one is connected via the band-pass filter 28 to a second TDMA demodulator 46 provided in the modulator/demodulator 4. The second one is connected via the low-pass filter 25 to an output terminal of the second frequency band provided for the power amplifier 3. The third one is connected to a duplexer 27 for CDMA. The duplexer 27 for CDMA is connected to a CDMA demodulator 45 provided in the modulator/demodulator 4 and connected via the power amplifier 3 to a CDMA modulator 44 provided in the modulator/demodulator 4. The second radio frequency switch 26 can switch the signal of the second frequency band in accordance with the timings for transmission and reception of the TDMA and can switch a connecting destination to the connection to the duplexer 27 for CDMA. By the above construction, transmission and reception signal paths of the TDMA and CDMA in the second frequency band can be properly switched and the signal can be transmitted and received to/from the modulator/demodulator 4.

The power amplifier 3 has a signal path for amplifying the first frequency band and a signal path for amplifying the second frequency band. The signal path for amplifying the first frequency band is a path between a first TDMA modulator 42 in the modulator/demodulator 4 and the low-pass filter 24 in the antenna duplexer 2. An output of the first TDMA modulator 42 is supplied to the antenna 1 by a radio frequency amplifier 31 via the first radio frequency switch 22 and the low-pass filter 29.

The signal path for amplifying the second frequency band is a signal path between a second TDMA modulator 43 or the CDMA modulator 44 provided in the modulator/demodulator 4 and the low-pass filter 25 or the duplexer 27 for CDMA in the antenna duplexer 2. Radio frequency switches 32 and 34 for switching the paths of the input and output signals are provided at the front stage (on the side of the modulator/demodulator 4) and the post stage (on the side of the antenna duplexer 2) of a radio frequency amplifier 33 provided in the above signal path, respectively. The radio frequency switch 32 at the front stage of the radio frequency amplifier 33 is selectively connected to the second TDMA modulator 43 at the time of the TDMA signal process and connected to the CDMA modulator 44 at the time of the CDMA signal process. The radio frequency switch 34 at the post stage of the radio frequency amplifier 33 is selectively connected to the low-pass filter 25 at the time of the TDMA signal process and connected to a transmission input of the duplexer 27 for CDMA at the time of the CDMA signal process. By the above construction, the amplification of the transmission signal of the second frequency band, that is, in the frequency range from the 1800 MHz band to the 2 GHz band can be executed by one radio frequency amplifier 33, and the circuit can be simplified.

The modulator/demodulator 4 has: the CDMA modulator 44; CDMA demodulator 45; first TDMA demodulator 41; first TDMA modulator 42; second TDMA modulator 43; and second TDMA demodulator 46. Each of the CDMA modulator 44, the first TDMA modulator 42, and the second TDMA modulator 43 modulates the output of the signal processor 5 in accordance with each method and outputs a transmission signal to the antenna duplexer 2 via the power amplifier 3 for amplifying it so that the signal is transmitted as a radio wave. Since the power amplifier amplifies an input of about 1 mW to an output of about 200 mW and handles a large electric power, a heat generation amount is large. Further, since the power amplifier includes the change-over switches 32 and 34, it is provided as an independent block. Each of the CDMA demodulator 45, the first TDMA demodulator 41, and the second TDMA demodulator 46 demodulates the output of the antenna duplexer 2 in accordance with each method and outputs the demodulated signal to the signal processor 5. Since it is unnecessary to amplify the output of the antenna duplexer 2 into a large electric power, in the embodiment, this output is supplied to the CDMA demodulator 45, first TDMA demodulator 41, and second TDMA demodulator 46 without passing through the power amplifier. If it is necessary to amplify the signal, an amplifying circuit is provided in the CDMA demodulator 45, first TDMA demodulator 41, and second TDMA demodulator 46.

The signal processor 5 has a function for forming modulation data and outputting it to the demodulator provided in the modulator/demodulator 4 and executes a process for converting an output signal from the modulator provided in the modulator/demodulator 4 into data, or the like.

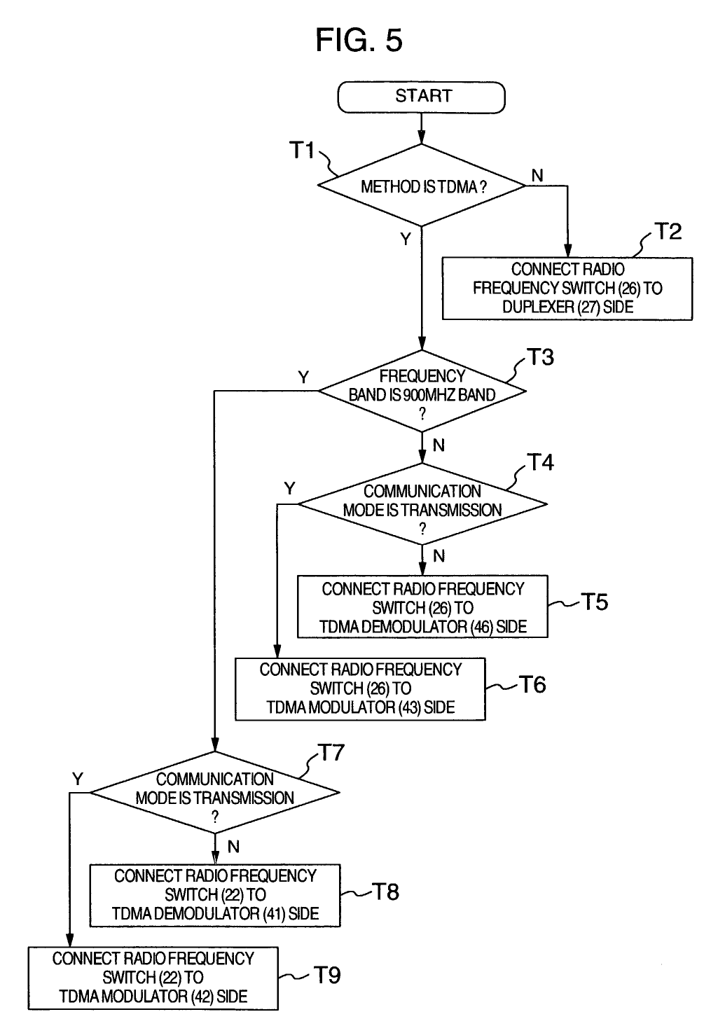

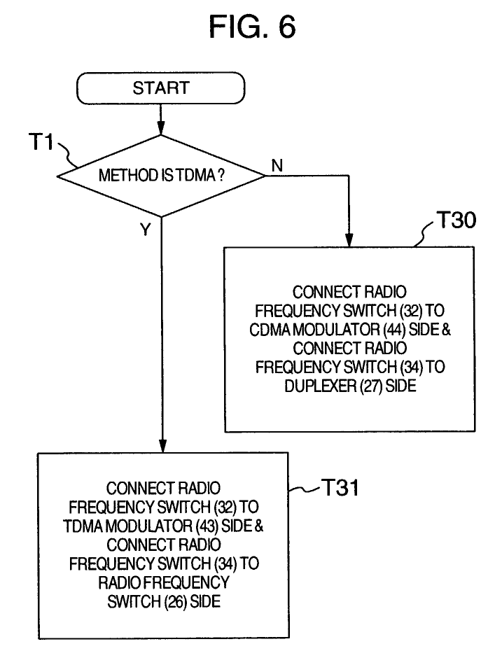

The controller 6 has a central processing unit (CPU) and discriminates a communication frequency band, the communication method of either the TDMA or the CDMA, and whether the communication is the reception or the transmission of the TDMA in accordance with a preinstalled program. In an interlocking relational manner with those conditions, the controller 6 controls the switching operations of the radio frequency switches provided in the antenna duplexer 2 and power amplifier 3. The switching control will be described with reference to FIGS. 5 and 6.

Upon switching of the switches in the antenna duplexer 2, as shown in FIG. 5, the CPU discriminates whether the communication method is the TDMA or not (step T1). If it is not the TDMA, the radio frequency switch 26 is connected to the duplexer 27 side (step T2), thereby allowing the signal to be transferred to the CDMA demodulator 45. In case of the TDMA, whether the frequency lies in the 900 MHz band or not is discriminated (step T3). If it is not the 900 MHz band, whether the communication mode is a transmission mode or not is discriminated (step T4). If it is not the transmission mode, the radio frequency switch 26 is connected to the TDMA demodulator 46 side (step T5). If it is the transmission mode in step T4, the radio frequency switch 26 is connected to the TDMA modulator 43 side (step T6). If it is determined in step T3 that the frequency lies in the 900 MHz band, whether the communication mode is a transmission mode or not is discriminated in step T7. If it is not the transmission mode, the radio frequency switch 22 is connected to the TDMA demodulator 41 side (step T8). On the other hand, if it is the transmission mode in step T7, the radio frequency switch 22 is connected to the TDMA modulator 42 side (step T9).

Upon switching of the radio frequency switches provided in the power amplifier 3, the CPU discriminates whether the communication method is the TDMA or not as shown in FIG. 6 (step T1). If it is not the TDMA, the radio frequency switch 32 is connected to the CDMA modulator 44 side and the radio frequency switch 34 is connected to the duplexer 27 side in step T30. Thus, the signal from the CDMA modulator 44 is amplified by the amplifier 33 and supplied to the duplexer 27. In case of the TDMA, the radio frequency switch 32 is connected to the TDMA modulator 43 side and the radio frequency switch 34 is connected to the radio frequency switch 26 side in step T31. Thus, the signal from the TDMA modulator 43 is amplified by the amplifier 33 and supplied to the radio frequency switch 26.

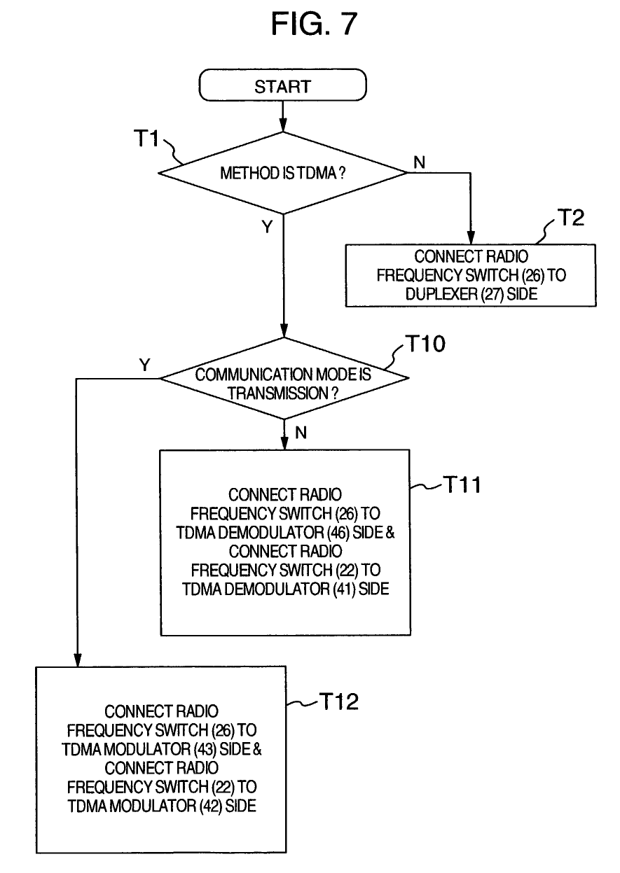

Subsequently, the switching operation shown in FIG. 7 will be descried. That is, the CPU discriminates whether the method is the TDMA or not (step T1). If it is not the TDMA, the radio frequency switch 26 is connected to the duplexer 27 side (step T2), thereby allowing the signal to be transferred to the CDMA demodulator 45. On the other hand, in case of the TDMA, whether the communication mode is the transmission mode or not is discriminated (step T10). If it is not the transmission mode, the radio frequency switch 26 is connected to the TDMA demodulator 46 side and the radio frequency switch 22 is connected to the TDMA demodulator 41 side (step T11). In case of the transmission mode in step T10, the radio frequency switch 26 is connected to the TDMA modulator 43 side via the low-pass filter 25 and the radio frequency switch 22 is connected to the TDMA modulator 42 side (step T12). Thus, the switching between the TDMA of the low frequency (first frequency band) and the TDMA of the high frequency (second frequency band) can be performed.

In the above embodiment, the antenna duplexer 2 and power amplifier 3 can be constructed as a module comprising a radio frequency board, chip parts, and the like. The power amplifier 3 is not limited to the module but can be also constructed by a semiconductor monolithic. The modulator/demodulator 4 can be also constructed by a semiconductor monolithic. In the embodiment, the signal processor 5 is constructed by a DSP (Digital Signal Processor), thereby raising a processing speed, and the controller 6 is constructed by a CPU.

According to the embodiment, the low-pass filter 29 which sets the first frequency band (900 MHz band) to a pass band and the high-pass filter 23 which sets the second frequency band (from the 1800 MHz band to the 2 GHz band) to a pass band are provided in the antenna connecting portion of the antenna duplexer 2 and the frequency is separated. Therefore, the communication of the first frequency band and the communication of the second frequency band can be simultaneously made, and the handover between both communication methods of the CDMA of the second frequency band and the TDMA of the first frequency band can be realized.

In the embodiment, since the first frequency band (900 MHz band) and the second frequency band (from the 1800 MHz band to the 2 GHz band) are frequency-separated by the duplexer, the simultaneous communication can be performed.

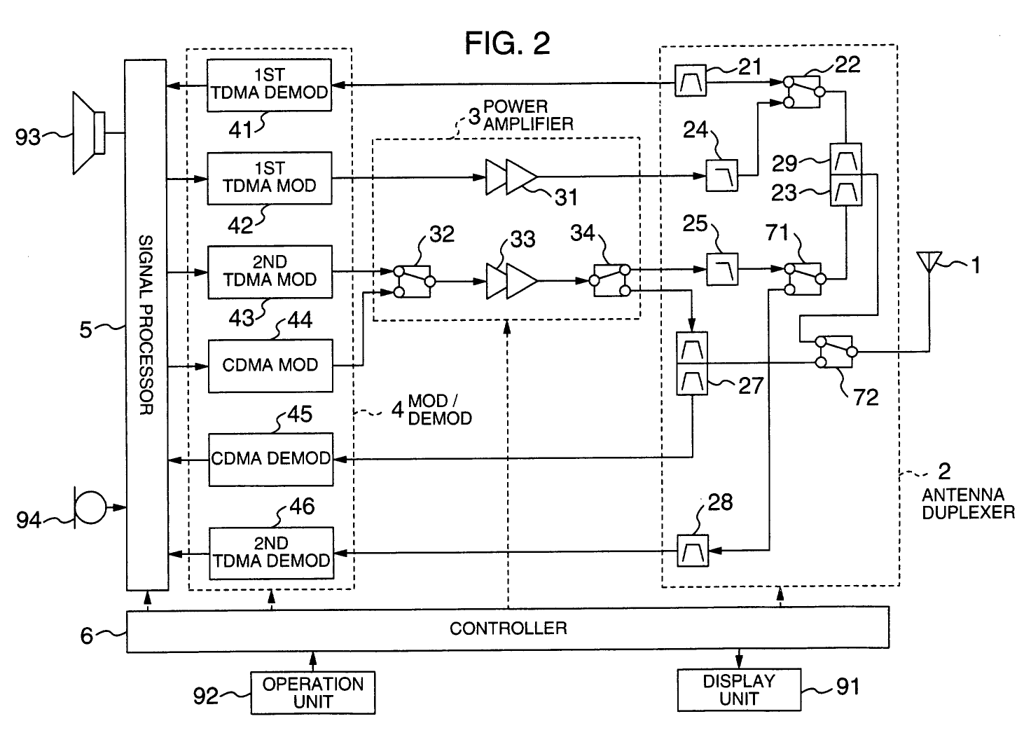

The second embodiment of the invention will now be described with reference to FIGS. 2, 8, and 9. FIG. 2 is a diagram showing a system construction of a TDMA/CDMA duplex communication terminal in the second embodiment. In the embodiment, although a construction of the antenna duplexer 2 differs from that in the first embodiment, other hardware constructions are similar to those in the first embodiment. A difference between the constructions of the antenna duplexers 2 will be described hereinbelow.

According to the antenna duplexer 2 in the second embodiment, a third radio frequency switch 72 for switching paths of the TDMA signal and the CDMA signal is provided in the antenna connecting portion. The low-pass filter 29 which sets the first frequency band to the pass band and the high-pass filter 23 which sets the second frequency band to the pass band are connected to a TDMA signal path which is switched by the third radio frequency switch 72. The duplexer 27 for CDMA is connected to a CDMA signal path which is switched by the third radio frequency switch 72.

The other signal terminal of the low-pass filter 29 is connected to the first radio frequency switch 22 which can switch the signal of the first frequency band in accordance with the transmission and reception timings of the TDMA. One of switching destinations of the first radio frequency switch 22 is connected to the first TDMA demodulator 41 provided in the modulator/demodulator 4 via the band-pass filter 21, and the other is connected to the output terminal of the first frequency band provided for the power amplifier 3 via the low-pass filter 24. By the above construction, the transmission and reception signal paths of the TDMA in the first frequency band can be properly switched and the signal can be transmitted and received to/from the modulator/demodulator 4.

The other signal terminal of the high-pass filter 23 is connected to a fourth radio frequency switch 71 which can switch the signal of the second frequency band in accordance with the transmission and reception timings of the TDMA. One of switching destinations of the fourth radio frequency switch 71 is connected to the second TDMA demodulator 46 provided in the modulator/demodulator 4 via the band-pass filter 28, and the other is connected to the output terminal of the second frequency band provided for the power amplifier 3 via the low-pass filter 25. By the above construction, the transmission and reception signal paths of the TDMA in the second frequency band can be properly switched and the signal can be transmitted and received to/from the modulator/demodulator 4.

The controller 6 controls the switching operations of the radio frequency switches provided in the antenna duplexer 2 and power amplifier 3 in an interlocking relational manner with the conditions such as communication frequency band, communication method of TDMA or CDMA, reception or transmission of the TDMA, and the like. The switching operations of the radio frequency switches 32 and 34 provided in the power amplifier 3 are shown in FIG. 6 in a manner similar to those in the first embodiment.

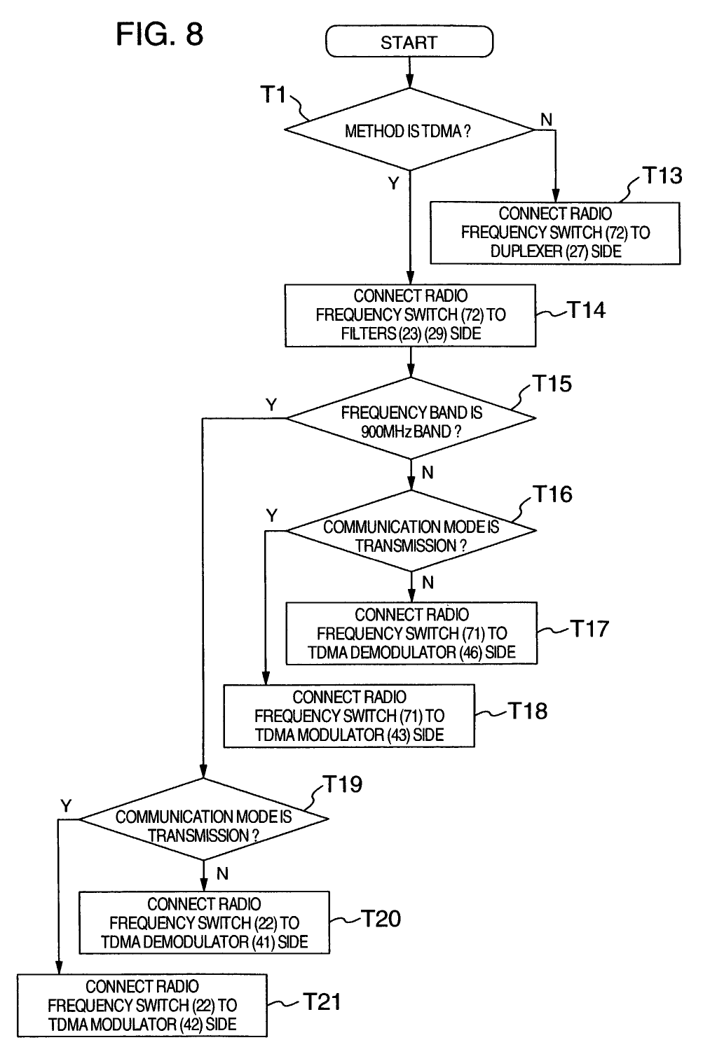

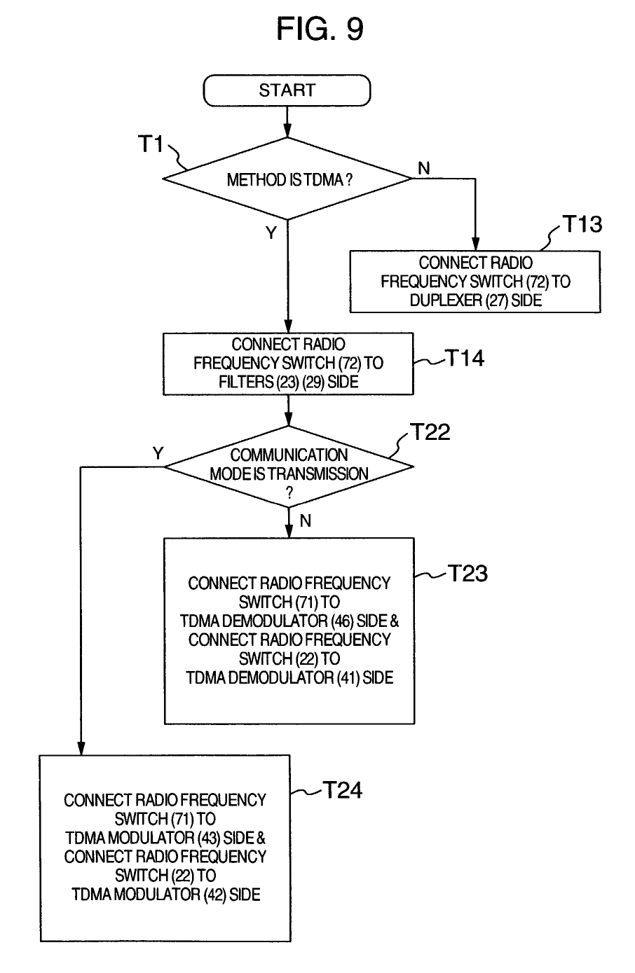

A switching control will be described with reference to FIGS. 8 and 9. The CPU discriminates whether the communication method is the TDMA or not (step T1). If it is not the TDMA, the radio frequency switch 72 is connected to the duplexer 27 side (step T13), thereby allowing the signal to be transferred to the CDMA demodulator 45. If it is the TDMA, the radio frequency switch 72 is connected to the sides of the filters 23 and 29 (step T14). Subsequently, whether the frequency lies within the 900 MHz band or not is discriminated (step T15). If it is not the 900 MHz band, whether the communication mode is the transmission mode or not is discriminated (step T16). If it is not the transmission mode, the radio frequency switch 71 is connected to the TDMA demodulator 46 side (step T17). If the communication mode is the transmission mode in step T16, the radio frequency switch 71 is connected to the TDMA modulator 43 side (step T18). If it is determined in step T15 that the frequency lies within the 900 MHz band, whether the communication mode is the transmission mode or not is discriminated in step T19. If it is not the transmission mode, the radio frequency switch 22 is connected to the TDMA demodulator 41 side (step T20). If the communication mode is the transmission mode in step T19, the radio frequency switch 22 is connected to the TDMA modulator 42 side (step T21).

Subsequently, the switching operation shown in FIG. 9 will be described. That is, the CPU discriminates whether the communication method is the TDMA or not (step T1). If it is not the TDMA, the radio frequency switch 72 is connected to the duplexer 27 side (step T13), thereby allowing the signal to be transferred to the CDMA demodulator 45. If it is the TDMA, the radio frequency switch 72 is connected to the sides of the filters 23 and 29 (step T14). Subsequently, whether the communication mode is the transmission mode or not is discriminated (step T22). If it is not the transmission mode, the radio frequency switch 71 is connected to the TDMA demodulator 46 side and the radio frequency switch 22 is connected to the TDMA demodulator 41 side (step T23). If the communication mode is the transmission mode in step T22, the radio frequency switch 71 is connected to the TDMA modulator 43 side and the radio frequency switch 22 is connected to the TDMA modulator 42 side (step T24). Thus, the switching operation can be performed between the TDMA of the low frequency and the TDMA of the high frequency.

According to the embodiment, the third radio frequency switch 72 for switching the paths of the TDMA signal and the CDMA signal is provided in the antenna connecting portion of the antenna duplexer 2 and the terminal which can automatically or manually switch the CDMA and the TDMA and use them can be realized. The manual switching is performed by inputting the desired method from the operation unit 92. For example, a dedicated switch can be also provided as an operation unit for the operation unit 92 (such a switch can be also allocated to the existing key on software). It is also possible to display a selection picture plane onto the display unit 91 and select and decide the desired method by a key input.

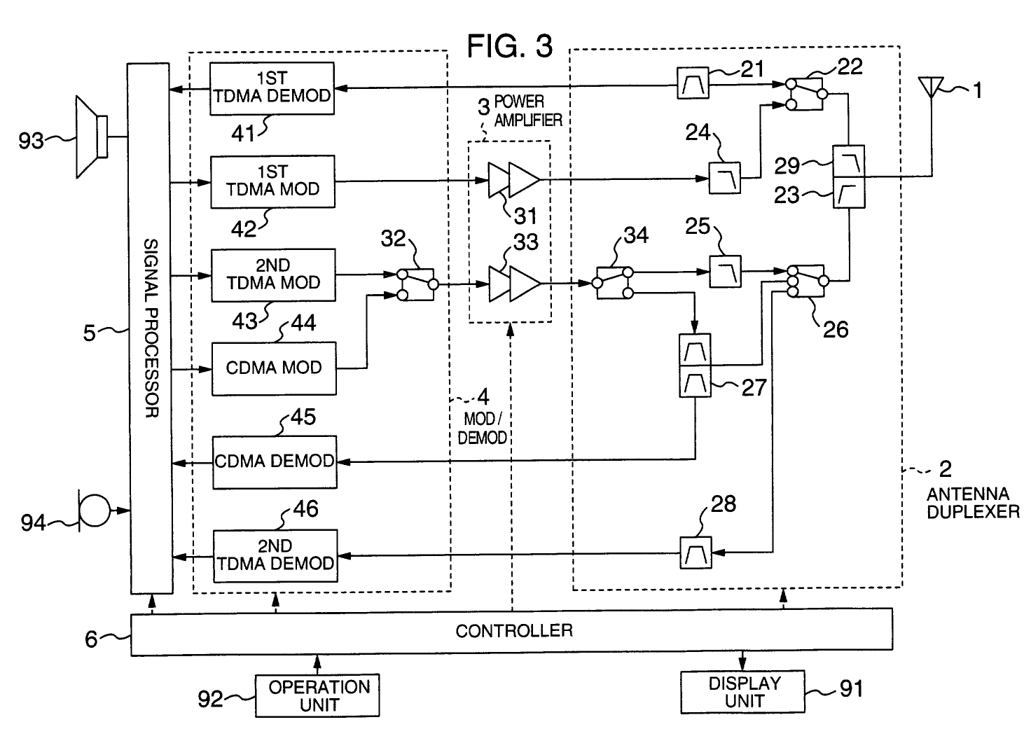

The third embodiment of the invention will be described with reference to FIG. 3. FIG. 3 is a diagram showing a system construction of a TDMA/CDMA duplex communication terminal in the embodiment. According to the third embodiment, although a construction of the antenna duplexer 2, power amplifier 3, and modulator/demodulator 4 differs from that of the first embodiment, other hardware constructions are similar to those of the first embodiment. A difference of the constructions of the antenna duplexer 2, power amplifier 3, and modulator/demodulator 4 between the first and third embodiments will be described hereinbelow.

According to the third embodiment, the radio frequency switch 34 for switching the transmission signal of the second frequency band which has been provided in the power amplifier 3 in the first embodiment is provided in the antenna duplexer and the radio frequency switch 32 for switching the transmission signal of the second frequency band is provided in the modulator/demodulator 4. According to this construction, there is a feature such that the construction of the power amplifier 3 can be simplified.

According to the third embodiment, the low-pass filter 29 which sets the first frequency band (900 MHz band) to the pass band and the high-pass filter 23 which sets the second frequency band (from the 1800 MHz band to the 2 GHz band) to the pass band are provided in the antenna connecting portion of the antenna duplexer 2 and the frequency is separated. Therefore, the communication of the first frequency band and the communication of the second frequency band can be simultaneously made and a handover between both communication methods of the CDMA and TDMA can be realized.

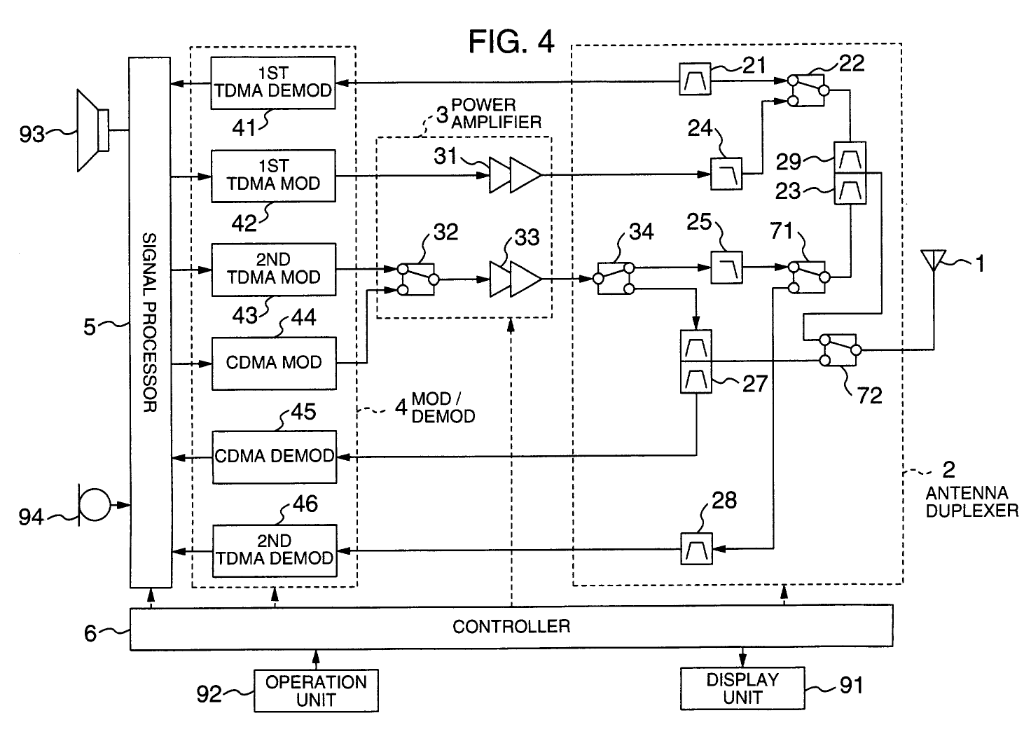

The fourth embodiment of the invention will be described with reference to FIG. 4. FIG. 4 is a diagram showing a system construction of a TDMA/CDMA duplex communication terminal in the embodiment. According to the fourth embodiment, although a construction of the antenna duplexer 2 and power amplifier 3 differs from that of the second embodiment, other hardware constructions are similar to those of the second embodiment. A difference of the constructions of the antenna duplexer 2 and power amplifier 3 between the second and fourth embodiments will be described hereinbelow.

According to the fourth embodiment, the radio frequency switch 34 for switching the transmission signal of the second frequency band which has been provided in the power amplifier 3 in the second embodiment is provided in the antenna duplexer. The fourth embodiment is characterized in that in the power amplifier 3, there is no need to provide a switch for an output unit where a large electric power passes but a switch is provided only for an input unit of a relatively small electric power, so that an internal circuit construction can be simplified.

According to the fourth embodiment, the third radio frequency switch 72 for switching the paths of the TDMA signal and the CDMA signal is provided in the antenna connecting portion of the antenna duplexer 2, and the terminal which can automatically or manually switch the CDMA and the TDMA and use them can be realized in a manner similar to the second embodiment.

For example, the TDMA in the foregoing embodiments is used in the cellular phones according to each system such as PDC (RCR STD-27) of Japan, GSM (TS100-910, etc.) of Europe, TIA IS-136 and UWC-136 of U.S.A., or the like. The CDMA is used in the cellular phones according to each of the systems such as ANSI JSTD-008 of U.S.A., ARIB STD-T63 and ARIB STD-T64 of Japan which are generally called cellular phones of the third generation, and a similar system of Europe.

In the above embodiments, there are the following frequency bands as a first frequency band. That is, ARIB STD-T53 (CDMA) of Japan (the reception side: 860-870 MHz, the transmission side: 915-925 MHz, the reception side: 843-846 MHz, the transmission side: 898-901 MHz, the reception side: 832-834 MHz, the transmission side: 887-889 MHz), IS-95 (CDMA, AMPS, TDMA) of U.S.A. and Korea (the reception side: 869-894 MHz, the transmission side: 824-849 MHz), GSM900 (TDMA) of Europe (the reception side: 921-960 MHz, the transmission side: 876-915 MHz), and PDC (TDMA) of Japan (the reception side: 810-826 MHz, 870-885 MHz, the transmission side: 925-956 MHz, the reception side: 834-846 MHz, the transmission side: 893-895 MHz). The AMPS is an analog method. If the first frequency band is the CDMA and AMPS, the band-pass filter 21, radio frequency switch 22, and low-pass filter 24 become one duplexer.

There are the following frequency bands as a second frequency band. That is, IMT-2000 (CDMA) (the reception side: 2110-2170 MHz, the transmission side: 1920-1980 MHz, the transmission and reception sides: 2000-2025 MHz), PCS (CDMA, TDMA) of North America (the reception side: 1930-1990 MHz, the transmission side: 1850-1910 MHz), PCS (CDMA) of Korea (the reception side: 1805-1870 MHz, the transmission side: 1715-1780 MHz), GSM1800 (TDMA) of Europe (the reception side: 1805-1880 MHz, the transmission side: 1710-1785 MHz), and PDC1.5G (TDMA) of Japan (the reception side: 1477-1501 MHz, the transmission side: 1429-1453 MHz).

When specific numerical values are designated as frequencies in the above embodiments, not only the frequencies specified by the numerical values but frequencies of a range necessary to make communication are included. Although the invention has been described on the assumption that a boundary frequency of the first and second frequency bands is set to 1 GHz, the invention is not limited to it but it is sufficient that a high/low relationship between the frequencies is held.

In the first and third embodiments of the invention shown in FIGS. 1 and 3, the handover between both communication methods of the TDMA in the first frequency band and the CDMA in the second frequency band is possible. The handover between the methods is not limited to the TDMA and the CDMA. For example, a handover between a first communication method whereby the transmission and the reception are executed at different time like a TDMA and a second communication method whereby the transmission and the reception are simultaneously executed like a CDMA is also possible. The second communication method is not limited to the method whereby the reception and the transmission are always simultaneously executed but it is also possible to use, for example, a method whereby the reception is intermittently executed during the transmission or a method whereby the transmission is intermittently executed during the reception.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A communication terminal which is adaptable to at least two communication methods, comprising:
first communicator which can communicate by a first method in a first frequency band;
second communicator which can communicate by a second method in a frequency band higher than said first frequency band;
third communicator which can communicate by a third method in a frequency band higher than said first frequency band; and
a selector which selects either said second communicator or said third communicator.

2. A terminal according to claim 1, wherein said first frequency band is equal to or lower than 1 GHz.

3. A terminal according to claim 1, wherein said second method and said third method are different methods and said first method is the same as either said second method or said third method.

4. A terminal according to claim 1, wherein said first method, said second method, and said third method are different methods.

5. A terminal according to claim 1, wherein said second method is a TDMA and said third method is a CDMA.

6. A terminal according to claim 5, wherein said first method is the TDMA.

7. A terminal according to claim 5, wherein said first method is an AMPS method.

8. A communication terminal which is adaptable to different communication methods of a TDMA in which transmission timing and reception timing are different and a CDMA including a timing when transmission and reception are simultaneously executed, comprising:
an antenna duplexer including an antenna, a low-pass filter which is connected to said antenna and sets a first frequency band to a pass band, a high-pass filter which is connected to said antenna and sets a second frequency band to a pass band, a first radio frequency switch which can switch a signal of said first frequency band in accordance with the transmission and reception timings of the TDMA, and a second radio frequency switch having a function for enabling a signal of said second frequency band to be switched in accordance with the transmission and reception timings of the TDMA and a function for switching a connecting destination to a connection to a duplexer for CDMA; and
a controller for controlling the switching operation of said radio frequency switches provided for said antenna duplexer in an interlocking relational manner with a communication mode of a modulator/demodulator.

9. A terminal according to claim 8, further comprising a power amplifier having at least a first signal path for amplifying the signal of said first frequency band and a second signal path for amplifying the signal of said second frequency band,
and wherein in said power amplifier, in said second signal path, third and fourth radio frequency switches for switching paths of input and output signals are provided at a front stage and a post stage of a radio frequency amplifier provided in said path,
one of connecting destinations of said third radio frequency switch provided at the front stage of said radio frequency amplifier is connected to a TDMA modulator provided for the terminal and the other is connected to a CDMA modulator,
one of connecting destinations of said fourth radio frequency switch provided at the post stage of said radio frequency amplifier is connected to the side of said second radio frequency switch provided for said antenna duplexer and the other is connected to a transmission input of said duplexer for CDMA, and
said controller controls the switching operation of each of said radio frequency switches provided for said antenna duplexer and said power amplifier in an interlocking relational manner with the communication mode of said modulator/demodulator.

10. A terminal according to claim 8, wherein:
a fifth radio frequency switch for switching output destinations of a power amplifier for amplifying the signal of said second frequency band provided for the communication terminal is included in said antenna duplexer; and
one of output destinations of said fifth radio frequency switch is connected to the side of said second radio frequency switch and the other is connected to a transmission input of said duplexer for CDMA.

11. A communication terminal which is adaptable to different communication methods of a TDMA in which transmission timing and reception timing are different and a CDMA including a timing when transmission and reception are simultaneously executed, comprising:
an antenna duplexer including a first radio frequency switch which is connected to an antenna and switches paths of a TDMA signal and a CDMA signal, a low-pass filter for TDMA which is connected to said first radio frequency switch and sets a first frequency band to a pass band, a high-pass filter for TDMA which is connected to said first radio frequency switch and sets a second frequency band to a pass band, a duplexer for CDMA connected to said first radio frequency switch, a second radio frequency switch which is connected to said low-pass filter for TDMA using said first frequency band as a pass band and can switch a signal of said first frequency band in accordance with the transmission and reception timings of the TDMA, and a third radio frequency switch which is connected to said high-pass filter for TDMA using said second frequency band as a pass band and can switch a signal of said second frequency band in accordance with the transmission and reception timings of the TDMA; and
a controller for controlling the switching operation of said radio frequency switches provided for said antenna duplexer in an interlocking relational manner with a communication mode of a modulator/demodulator.

12. A terminal according to claim 11, further comprising a power amplifier having at least a first signal path for amplifying the signal of said first frequency band and a second signal path for amplifying the signal of said second frequency band,
and wherein in said power amplifier, in said second signal path, fourth and fifth radio frequency switches for switching paths of input and output signals are provided at a front stage and a post stage of a radio frequency amplifier provided in said path,
one of connecting destinations of said fourth radio frequency switch provided at the front stage of said radio frequency amplifier is connected to a TDMA modulator and the other is connected to a CDMA modulator,
one of connecting destinations of said fifth radio frequency switch provided at the post stage of said radio frequency amplifier is connected to the side of said third radio frequency switch provided for said antenna duplexer and the other is connected to a transmission input of said duplexer for CDMA, and
said controller controls the switching operation of each of said radio frequency switches provided for said antenna duplexer and said power amplifier in an interlocking relational manner with the communication mode of said modulator/demodulator.

13. A terminal according to claim 11, wherein:
a fourth radio frequency switch for switching output destinations of a power amplifier for amplifying the signal of said second frequency band provided for the communication terminal is included in said antenna duplexer; and
one of output destinations of said fourth radio frequency switch is connected to the side of said third radio frequency switch and the other is connected to a transmission input of said duplexer for CDMA.

14. An antenna duplexer which is adaptable to a communication terminal which is adaptable to different communication methods of a TDMA in which transmission timing and reception timing are different and a CDMA including a timing when transmission and reception are simultaneously executed, comprising:
a low-pass filter which is connected to an antenna and sets a first frequency band to a pass band;
a high-pass filter which is connected to said antenna and sets a second frequency band to a pass band;
a first radio frequency switch which can switch a signal of said first frequency band in accordance with transmission and reception timings of the TDMA; and
a second radio frequency switch having a function for enabling a signal of said second frequency band to be switched in accordance with the transmission and reception timings of the TDMA and a function for switching a connecting destination to a connection to a duplexer for CDMA.

15. An antenna duplexer which is adaptable to a communication terminal which is adaptable to different communication methods of a TDMA in which transmission timing and reception timing are different and a CDMA including a timing when transmission and reception are simultaneously executed, comprising:
a first radio frequency switch which is connected to an antenna and switches paths of a TDMA signal and a CDMA signal;
a low-pass filter for TDMA which is connected to said first radio frequency switch and sets a first frequency band to a pass band;
a high-pass filter for TDMA which is connected to said first radio frequency switch and sets a second frequency band to a pass band;
a duplexer for CDMA connected to said first radio frequency switch;
a second radio frequency switch which is connected to said low-pass filter for TDMA using said first frequency band as a pass band and can switch a signal of said first frequency band in accordance with the transmission and reception timings of the TDMA; and
a third radio frequency switch which is connected to said high-pass filter for TDMA using said second frequency band as a pass band and can switch a signal of said second frequency band in accordance with the transmission and reception timings of the TDMA.

16. A duplexer according to claim 14, further comprising a third radio frequency switch which receives a modulation signal of said second frequency band and switches its output destinations,
and wherein one of output destinations of said third radio frequency switch is connected to the side of said second radio frequency switch and the other is connected to a transmission input of said duplexer for CDMA.

17. A duplexer according to claim 15, further comprising a fourth radio frequency switch which receives a modulation signal of said second frequency band and switches its output destinations,
and wherein one of output destinations of said fourth radio frequency switch is connected to the side of said third radio frequency switch and the other is connected to a transmission input of said duplexer for CDMA.

18. A power amplifier which is adaptable to a communication terminal which is adaptable to different communication methods of a TDMA in which transmission timing and reception timing are different and a CDMA including a timing when transmission and reception are simultaneously executed, wherein:
at least a signal path for amplifying a signal of a first frequency band and a signal path for amplifying a signal of a second frequency band are provided;
in the signal path for amplifying the signal of said second frequency band, first and second radio frequency switches for switching paths of input and output signals are provided at a front stage and a post stage of a radio frequency amplifier provided in said path;
one of connecting destinations of said first radio frequency switch provided at the front stage of said radio frequency amplifier is connected to a TDMA modulation signal input terminal and the other is connected to a CDMA modulation signal input terminal; and
one of connecting destinations of said second radio frequency switch provided at the post stage of said radio frequency amplifier is connected to a TDMA modulation signal output terminal and the other is connected to a CDMA modulation signal output terminal.

19. A terminal according to claim 8 or 11, wherein said first frequency is a frequency which is equal to or lower than 1 GHz, and said second frequency is a frequency which is higher than 1 GHz.

20. A duplexer according to claim 14 or 15, wherein said first frequency is a frequency which is equal to or lower than 1 GHz, and said second frequency is a frequency which is higher than 1 GHz.

21. An amplifier according to claim 18, wherein said first frequency is a frequency which is equal to or lower than 1 GHz, and said second frequency is a frequency which is higher than 1 GHz.
